(19) United States
(12) Patent Application Publication
(10) Pub. No.: US 2005/0255192 A1
(43) Pub. Date: Nov. 17, 2005

(54) Yogurt products and method of preparation

(76) Inventors: Prerna Chaudhry, Eden Prairie, MN (US); Maeve C. Murphy, Plymouth, MN (US); Caroline M. Franke, Plymouth, MN (US); Joana A. Montenegro, Prior Lake, MN (US)

Correspondence Address: GENERAL MILLS, INC., P.O. BOX 1113, MINNEAPOLIS, MN, 55440, US

(21) Appl. No.: 11/127,714

(22) Filed: May 12, 2005

Related U.S. Application Data
(60) Provisional application No. 60/570,551, filed on May 13, 2004.

(51) Int. Cl. A23C 9/12

(52) U.S. Cl. 426/43

(57) ABSTRACT

The invention provides methods for preparing a cultured dairy product having reduced fermentation times. The methods for preparing a cultured dairy product comprises the post fermentation addition of carbohydrate sweetening agents and/or preservative(s). The methods described herein are useful in food products such as yogurt, other refrigerated milk products, and fermented soy, rice and nut milk products, and beverages.

### REFFERENCE TO RELATED APPLICATIONS

This application claims the benefit of priority under 35 U.S.C. § 119(e)(1) of a provisional patent application, Ser. No. 60/570,551, filed May 13, 2004, which is incorporated herein by reference in its entirety.

### FIELD OF THE INVENTION

The invention relates to food products and to their methods of preparation. More particularly, the invention relates to cultured dairy products, especially cultured yogurt products and to their methods of preparation.

### BACKGROUND OF THE INVENTION

Yogurt is a nutritious popular dairy product. At retail, yogurt is now available in a wide assortment of varieties of texture, fat content, sweetener type and level, and flavor among other attributes. Other than aseptically packaged yogurt, yogurt is generally distributed and consumed with a live culture that requires refrigerated distribution at 2° C. to 10° C. (36° F. to 50° F.).

From a yogurt manufacturing process standpoint, all yogurts generally fall into one of two styles; namely, 1) set yogurts, and 2) stirred style. Within these broad two classifications, numerous yogurt varieties exist.

In producing stirred yogurt products, a manufacturer typically 1) ferments an inoculated dairy base mix in bulk, e.g., in large stirred fermentation or culturing tanks; 2) cools the yogurt so formed to arrest the fermentation; and then 3) fills the individual yogurt container with thickened yogurt. Production facilities producing the yogurt are run in a continuous or semi-continuous manner. Furthermore, such production facilities experience a great deal of variability with respect to production run schedules as a result of lengthy and variable fermentation times that can result from standard processing procedures and formulation variability. The fermentation time of the same basic formula can vary from anywhere from ten minutes to sixty minutes. A number of factors can affect the fermentation time variability of the yogurt production process, such as starter culture selection, bacteriophage, fermentation temperatures, formulations, total solids content of the formulation, and operator error in the addition of ingredients to the formulation.

Generally, the process of producing stirred yogurt products more specifically includes; fermenting a dairy base mix comprising carbohydrate sweetening agent(s) and preservative(s) to produce a yogurt of desired acidity and thickness, thereafter the yogurt is pumped through cooling heat exchangers to arrest the fermentation. Alternatively, the yogurt can be cooled in a two stage process to reduce shear and maximize the viscosity of the product. In a two stage process the yogurt can be first cooled to 21° C. (70° F.) via a cooling plate, thereafter the yogurt can be cooled to 4° C. (40° F.) via a cooling tunnel. Flavorings and sweeteners can be admixed with the cooled yogurt and the yogurt can be charged to containers. Care needs to be taken to minimize the shear imparted to the yogurt in practicing such process steps to minimize the loss of thickness or viscosity built up by the fermentation step. Thus, the stirred style yogurt typically has a higher viscosity than set style yogurts upon filling due to the lower temperature and the thickening affect of yogurt culture. Nonetheless, the stirred style yogurt typically builds or increases substantially in viscosity after filling over time until reaching its intended finish viscosity. Of course, stirred yogurts come in various styles and product variations.

Generally, yogurt manufacturing provides the addition of carbohydrate sweetening agent(s) and preservative(s) into the dairy base mix prior to fermentation, see FIG. 1.

One of the main objectives of adding carbohydrate sweetening agent(s) to a yogurt product is to tone down or minimize the acidic taste of the product. Preservative(s) are added to a yogurt product to inhibit yeast and mold growth in the product. The addition of carbohydrate sweetening agent(s) and preservative(s) in the cultured dairy product pre-fermentation has generally been necessary due to the need to heat treat or sterilize the carbohydrate sweetening agent(s) and preservative(s) to ensure no undesirable bacterial growth interaction in the finished cultured yogurt product. Additionally, carbohydrate sweetening agent(s) and preservative(s) have generally been admixed with the dairy base mix pre-fermentation, as the pre-fermentation addition minimized the complexity of the yogurt production process via admixture of most ingredients in one step.

Furthermore, in some countries regulations have not permitted the post fermentation addition of ingredients that do not contribute to the products flavor.

Commonly, fruit sauces or purees are optionally stirred into the stirred yogurt immediately prior to filling. Such stirred style yogurts comprising intermixed fruit purees are often referred to as “Swiss” style or, sometimes as “Continental” or “French” style. Occasionally, stirred Swiss style yogurts are formulated with excessive amounts of stabilizer(s) with the result that after upon refrigerated storage for 48 hours, the yogurt possesses a solid-like consistency, somewhat reminiscent of custard style yogurt. In some instances carbohydrate sweetening agent(s) and preservative(s) are added to the fruit sauces or purees prior to admixing into the stirred yogurt. However, only limited amounts of carbohydrate sweetening agent(s) can be added to the fruit sauces or purees, as the sauces or purees will become saturated and the carbohydrate sweetening agent(s) will not disperse or dissolve in the sauce or puree, resulting in a finished yogurt product having a granular texture. Additionally, fruit sauces or purees are not always added to a yogurt (e.g. plain yogurt, vanilla flavored yogurt, caramel flavored yogurt, chocolate flavored yogurt, etc.), thus addition of a carbohydrate sweetening agent(s) or preservative(s) into a fruit sauce or puree is not possible.

As can be appreciated from the above description of the numerous styles and flavors within styles of yogurts, product proliferation and differentiation is an important characteristic of commercial yogurt manufacture. As can be further appreciated the numerous styles, product proliferation and differentiation in yogurt products results in numerous manufacturing parameters and fermentation times across the field of yogurt styles. The variability in product of one style or flavor compared to another causes operational problems in manufacturing ranging from scheduling, capacity, product quality, and overuse.

Additionally, yogurt styles or bases having long fermentation times (e.g. greater than four hours) can exhibit greater variability and less predictability during the fermentation step, thus increasing production operation problems.

Surprisingly, the above limitations and difficulties have now been overcome and the invention satisfies the above objectives.

### BRIEF SUMMARY OF EMBODIMENTS OF THE INVENTION

Embodiments of the invention provide dairy products and methods of preparing cultured dairy products such as stirred style yogurt. The present methods reside in part in the post fermentation addition of a carbohydrate sweetening agent(s) to cultured dairy products, more specifically yogurt products. Furthermore, the present methods further reside in part in the post fermentation addition of a preservative(s) to cultured dairy products, more specifically yogurt products. Additionally, the present methods reside in part in the post fermentation addition of stabilizer(s) to cultured dairy products, more specifically yogurt products.

Post fermentation addition of carbohydrate sweetening agent(s), preservative(s), and stabilizer(s) to cultured yogurt has been found to provide greater efficiency, such as, for example, improved fermentation times and improved management and predictability of the yogurt production process.

The invention finds particular suitability for use in connection with the provision of stirred style yogurts.

Embodiments of the invention provide methods for preparing an improved cultured dairy product having decreased fermentation times. In one embodiment, preparation comprises:
A. providing a heat treated dairy base mix comprising:
   a. about 4% to 12% milk solids;
   b. about 0.1% to 6% fat;
   c. about 0% to 25% carbohydrate sweetening agent(s);
   d. about 0.2% to 1.2% stabilizer(s);
B. inoculating the heat treated dairy base mix with a starter culture to form an inoculated dairy base;
C. fermenting the inoculated dairy base mix to provide a cultured dairy base mix;
D. cooling the cultured dairy base to a temperature of about 0° to 5° C. to arrest fermentation;
E. adding about 0% to about 25% of a heat treated carbohydrate sweetening agent(s); and
F. adding about 0.005% to 0.20% of a heat treated preservative(s) to the cultured dairy base mix.

In another embodiment, preparation comprises:
A. providing a heat treated dairy base mix comprising:
   a. about 4% to 12% milk solids;
   b. about 0.1% to 6% fat;
   c. about 0% to 25% carbohydrate sweetening agent(s);
B. inoculating the heat treated dairy base mix with a starter culture to form an inoculated dairy base mix;
C. fermenting the inoculated dairy base mix to provide a cultured dairy base mix;
D. cooling the cultured dairy base mix to a temperature of about 0% to 5% to arrest fermentation;
E. adding:
   a. about 0% to about 25% of a heat treated carbohydrate sweetening agent(s);
   b. about 0.005% to 0.20% of a heat treated preservative(s); and
   c. about 0.2% to 1.2% of a heat treated stabilizer(s) to the cultured dairy base mix.

Another object of the invention is to provide customizable cultured dairy base mix, thereby allowing for post-fermentation customization of the cultured dairy base mix.

These and other objects will become increasingly apparent by reference to the following description.

### BRIEF DESCRIPTION OF THE DRAWINGS

FIG. 1 is a schematic process flow diagram illustrating the method of preparation of a conventional cultured dairy base process.

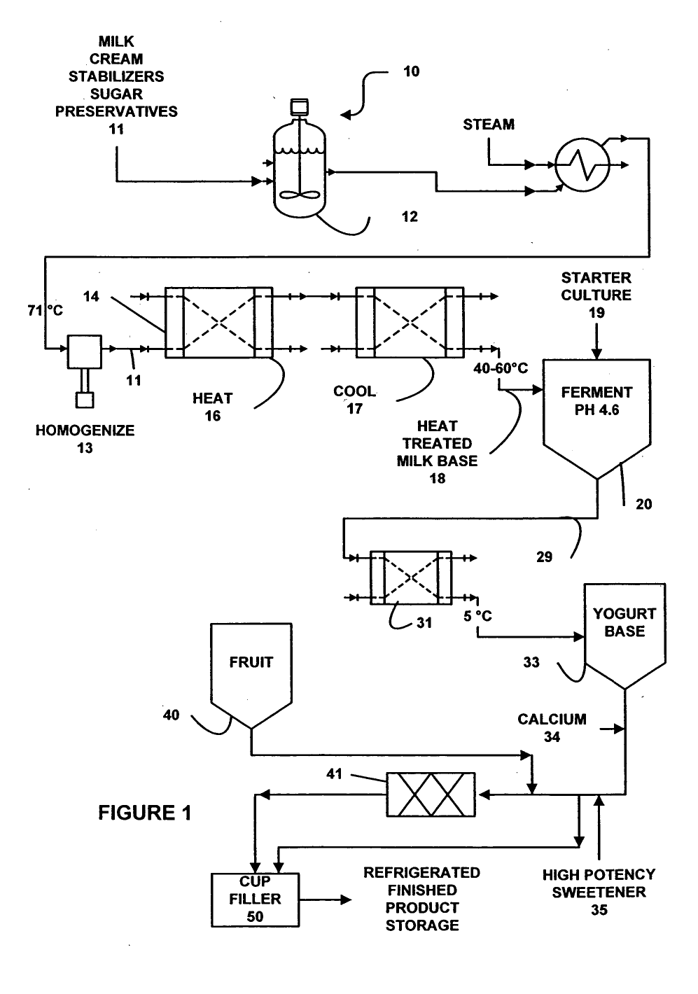

FIG. 2 is a schematic process flow diagram illustrating a method of preparation according to an embodiment of the invention.

### DETAILED DESCRIPTION OF EMBODIMENTS OF THE INVENTION

The invention is directed to a process for preparing a yogurt product having reduced production times, more specifically a yogurt having reduced fermentation times comprising a carbohydrate sweetening agent(s) and a preservative(s).

A number of ingredients generally added to a dairy base mix prior to fermentation of a cultured dairy products have inhibitory effects on the fermentation during the production process.

More specifically, carbohydrate sweetening agent(s) and preservative(s) have inhibitory effects on the fermentation times of cultured dairy products, thereby increasing the fermentation times of the cultured dairy products production process.

The elimination or reduction of carbohydrate sweetening agent(s) in the pre-fermentation process of cultured dairy products decreased the fermentation time in the production of the cultured dairy product by at least 18%, thereby decreasing the overall production time. In certain embodiments, the decrease in fermentation time can be at least 15%. In other certain embodiments, the decrease in fermentation time can be at least 35%.

Furthermore, the elimination of preservative(s) in the pre-fermentation process of cultured dairy products decreased the fermentation time in the production of the cultured dairy product by at least 13%, thereby decreasing the overall production time. In certain embodiments, the decrease in fermentation time can be at least 15%.

Additionally, the combined elimination or reduction of carbohydrate sweetening agent(s) and the elimination of preservative(s) in the pre-fermentation process of cultured dairy products provides the most synergistic decrease in the fermentation time in the production of the cultured dairy products by at least a 24% decrease in fermentation time, thereby decreasing the overall production time. In certain embodiments, the decrease in fermentation time can be at least 30%. In other certain embodiments, the decrease in fermentation time can be at least 40%.

More specifically, the elimination of preservative(s) such as potassium sorbate, sodium benzoate and mixtures thereof in the pre-fermentation process of cultured dairy products improved the fermentation time of the cultured dairy product. The elimination of preservative(s) in the pre-fermentation process can be particularly suitable for dairy base mixes containing a percentage of total solids of at least 15%. In certain embodiments, the elimination of preservative(s) in the pre-fermentation process can be particularly suitable for dairy base mixes containing a percentage of total solids of at least 25%. Additionally, the elimination in the pre-fermentation process of at least a portion of the carbohydrate sweetening agent(s) either independently or in combination with the elimination of preservative(s) in the pre-fermentation process significantly reduced the fermentation time. The elimination or reduction of carbohydrate sweetening agent(s) was particularly suitable for dairy base mixes containing a percentage of total solids of at least 15%. In certain embodiments, the elimination or reduction of carbohydrate sweetening agent(s) was particularly suitable for dairy base mixes containing a percentage of total solids of at least 25%.

Additionally, it has been found that the post fermentation addition of carbohydrate sweetening agent(s), preservative(s), and other ingredients such as stabilizer(s) that have generally been added in the pre-fermentation process provides a customizable cultured dairy base, thereby reducing the number of base formulations needed to produce a variety of yogurt products and decreasing the operational problems such as scheduling, capacity, product quality, and overuse associated with having numerous dairy base formulations.

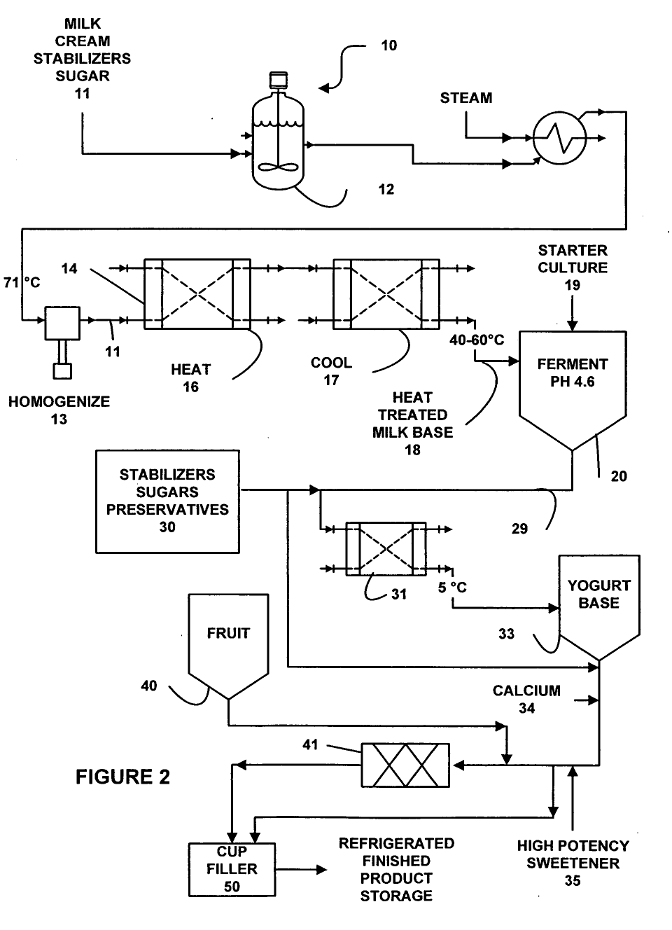

Referring now to FIG. 2, an embodiment of a method according to the invention is provided for preparing a cultured dairy product generally designated by reference numeral 10. Methods 10 comprises providing a fermented stirred dairy base 20, admixing a carbohydrate sweetening agent(s), stabilizer(s), and preservative(s) blend 30 to the fermented dairy base and, filling containers 50 with a cultured dairy product, such as yogurt.

During fermentation the methods 10 can comprise providing a dairy base 11, admixing the dairy base 12, optionally homogenizing the dairy base mix 13, heat treating the homogenized dairy base mix 16, bringing the pasteurized dairy base mix to fermenting temperatures 17, such as by cooling to produce a heat treated dairy base 18, adding a starter culture 19, and fermenting to desired acidities 20.

Briefly, the process typically begins with forming or providing a dairy base mix comprising at least one fermentable dairy ingredient. The fermentable dairy ingredient can comprise raw milk but can contain alone or in combination whole milk, skim milk, condensed milk, dry milk (dry milk solids non-fat or, equivalently, “MSNF”), grade A whey, cream and/or such other milk fraction ingredients as buttermilk, whey, lactose, lactalbumins, lactoglobulins, or whey modified by partial or complete removal of lactose and/or minerals, other dairy ingredients to increase the nonfat solids content, which are blended to provide the desired fat and solids content. The milk base can include a filled milk component, i.e., a milk ingredient having a portion supplied by a non-milk ingredient, e.g., oil or soybean milk.

The method can comprise the optional removal of water from the dairy base mix to allow for addition of water in a post fermentation addition of a carbohydrate sweetening agent(s)/water blend 30 to the fermented dairy base.

Processes according to the invention are also suitable for use in a wide variety of food products, such as other fermented milk products, fermented soy, rice and nut milk products, beverages and whipped toppings.

Other milks can also be used in substitution for bovine milk whether in whole or in part, e.g., camel, goat, sheep, equine milk or mixtures thereof. The base mix can comprise a vegetable milk such as soy milk.

The dairy base mix 11 can further include carbohydrate sweetening agent(s). The dairy base mix 11 can optionally comprise a quantity of about 0% to about 25% of a carbohydrate sweetening agent(s). Exemplary useful carbohydrate sweetening agent(s) include, but are not limited to, sucrose, liquid sucrose, high fructose corn syrup, liquid dextrose, dextrose, various DE corn syrups, corn syrup solids, beet or cane sugar, invert sugar (in paste or syrup form), brown sugar, refiner's syrup, molasses (other than blackstrap), fructose, fructose syrup, maltose, maltose syrup, dried maltose syrup, malt extract, dried malt extract, malt syrup, dried malt syrup, honey, maple sugar and mixtures thereof.

The dairy base mix ingredients and carbohydrate sweetening agent(s) (such as fructose, corn syrup, or sucrose) can be blended in a mix tank 12. Stabilizer(s) such as gelatin, starch, pectin, agar and carrageenan and mixtures thereof may also be added if desired.

In an exemplary embodiment of the invention, sucrose can be added to the dairy base mix 11. Eliminating the carbohydrate sweetening agent(s) substantially, as opposed to only removing a portion of the carbohydrate sweetening agent(s), in the dairy base mix provides insignificant additional benefit in the reduction of fermentation times. However, the substantial elimination of the carbohydrate sweetening agent(s) can provide significant fermentation time benefit for certain culture strain blends. While not wishing to be bound by the proposed theory, it is presently believed that in certain embodiments the substantial elimination of the carbohydrate sweetening agent(s) pre-fermentation does not alter the fermentation time in an significant manner as a result of the culture strain blend having reached the maximum acid production rate for the specific strain. Therefore, substantial elimination of the carbohydrate sweetening agent(s) pre-fermentation can be desirable.

The dairy base mix can further comprise a bovine, porcine, or piscine gelatin. A bovine gelatin in the range of about 200 to 250 bloom strength can be used; also, Type B bovine gelatin in the range of about 220 to 230 bloom strength is suitable.

The dairy base ingredients are admixed to form a homogeneous or well blended mix. Next, the dairy base mix 11 is optionally homogenized 13 in a conventional homogenizer to disperse evenly the added materials and the fat component supplied by various ingredients thereby forming a homogenized dairy base mix 14. If desired, the dairy base mix 11 can be warmed prior to homogenization from typical milk storage temperatures of about 5° C. (41° F.) to temperatures of about 65° C. to about 75° C. (149° F. to about 167° F.), such as about 71° C. (160° F.).

Further continuing in the process depicted in FIG. 2, the homogenized dairy base mix 14 is then essentially heat treated or pasteurized 16, typically by heating for times and temperatures effective to accomplish pasteurization to form a pasteurized or heat treated dairy base mix or blend 18. The dairy base mix 11 can be heated to lower temperatures for extended times, e.g., 88° C. (190° F.) for 30 minutes, or alternately to higher temperatures, e.g., 95° C. (203° F.), for shorter times, e.g., for about 38 seconds. Intermediate temperatures for intermediate times can also be employed. Other pasteurization techniques or sterilization, can be practiced (e.g., light pulse, ultra high temperature, ultra high pressure, etc.). In certain commercial practices, the sequence of the homogenization and pasteurization steps can be reversed.

In an exemplary embodiment of the invention a pasteurized dairy base mix comprising a dairy base having a moisture content of about 70% to about 85% and a pH of about 6.0 to 6.6 and comprising about 0.01% to about 5% of a culture or a cultured dairy ingredient can be used.

The homogenized and pasteurized dairy base mix is then brought to incubation temperature, usually about 40° C. to 46° C. (104° F. to 115° F.). When heat pasteurization is employed, the homogenization and pasteurization typically is followed by a cooling step 17. Thereafter, the homogenized and pasteurized dairy blend mix is inoculated with a desired starter culture 19 such as a starter yogurt culture or a cultured dairy ingredient. For example, a yogurt starter culture includes a combination of Lactobacillus bulgaricus (Lactobacillus delbrucki subsp. bulgaricus) and Streptococcus thermophilus. In other variations, the culture can additionally include a Lactobacillus acidophilus, Lactobacillus bifidus, Lactobacillus subsp. casei, Lactobacillus delbrucki subsp. lactis, Lactobacillus rhamnosus, Bifidobacterium bifidus, and/or Bifidobacterium lactis bacteria.

The methods further comprise a fermentation process 20. In an exemplary embodiment of the invention, preparation of a yogurt herein; the fermentation process 20, is quiescently continued until the pH of the inoculated dairy base mix blend reaches approximately 4.2 to 4.9 to form a cultured dairy base mix 29. In certain embodiments, the fermentation process 20, is quiescently continued until the pH of the inoculated dairy base mix blend reaches approximately 4.4 to about 4.6 to form a cultured dairy base mix 29. Depending upon temperature and amount of culture added, the fermentation process may take from about three to about 14 hours. In the preparation of a stirred style yogurt product, it is important that the mixture agitation be minimized during the fermentation process to allow proper curd formation. After fermentation to desired acidity and thickness, the cultured dairy base can be pumped through cooling heat exchangers 31 to arrest the fermentation.

Thereafter, the methods comprise admixing about 0% to about 25% of a carbohydrate sweetening agent(s) and about 0.005% to about 0.20% of preservative(s) into the cultured dairy base mix 30. In certain embodiments, about 0.01% to about 0.10% of preservative(s) blend can be admixed into the cultured dairy base mix. Alternatively, the methods comprise admixing carbohydrate sweetening agent(s) into the cultured dairy base mix and thereafter admixing preservative(s) blend into the cultured dairy base mix or vice versa. A static mixer 41 can be used to blend the sweetening agent(s) and preservative(s) into the cultured dairy base mix with minimal shear.

A variety of pumps well known in the art can be used to inject the carbohydrate sweetening agent(s) and preservative(s) into the cultured dairy base mix. For example, a positive displacement pump can be used to inject the carbohydrate sweetening agent(s) or the carbohydrate sweetening agent(s)/preservative(s) blend into the cultured dairy base mix. A Universal Series II model pump manufactured by Waukesha Cherry-Burrell, Inc. having an address at 611 Sugar Creek Rd., Delavan, Wis. 53115 can be used to inject the carbohydrate sweetening agent(s) or carbohydrate sweetening agent(s)/preservative(s) blend into the cultured dairy base mix. A peristaltic pump, for example a Masterflex LN model pump distributed by Cole-Palmer Instrument Company having an address at 625 East Bunker Court, Vernon Hills, Ill. 60061 can be used to inject the preservative(s) into the cultured dairy base mix.

Exemplary useful carbohydrate sweetening agent(s) include, but are not limited to, sucrose, high fructose corn syrup, dextrose, various DE corn syrups, beet or cane sugar, invert sugar (in paste or syrup form), brown sugar, refiner's syrup, molasses (other than blackstrap), fructose, fructose syrup, maltose, maltose syrup, dried maltose syrup, malt extract, dried malt extract, malt syrup, dried malt syrup, honey, maple sugar, except table syrup and mixtures thereof. In an exemplary embodiment of the invention, high fructose corn syrup containing about 17% to about 25% water can be admixed with the cultured dairy base mix; high fructose corn syrup is preferred for use herein. Fructose, fructose syrup, and high fructose corn syrup can have a more deleterious effect on starter cultures in comparison to other carbohydrate sweetening agent(s) added to the heat treated milk base pre-fermentation.

In an alternative embodiment the carbohydrate sweetening agent(s) are admixed with water to form a carbohydrate sweetening agent(s) blend. The carbohydrate sweetening agent(s) blend can be beneficial in the process of sterilization or pasteurization of the carbohydrate sweetening agent(s) blend, prior to admixture with the cultured dairy base mix. The carbohydrate sweetening agent(s) to water can be blended in a ratio of about 1:1 to about 4:1.

In an embodiment wherein the carbohydrate sweetening agent(s) blend has a concentration of water greater than 20%, water can be removed from the dairy base mix 11 to account for moisture addition post fermentation.

In an exemplary embodiment of the invention, the carbohydrate sweetening agent(s) can be admixed with the cultured dairy base mix at a temperature of about 4° C. to about 15° C. (39° F. to about 59° F.) either immediately before or immediately after a holding tank 33. In certain embodiments, the carbohydrate sweetening agent(s) can be admixed with the cultured dairy base mix at a temperature of about 4° C. to about 7° C. (39° F. to about 45° F.) either immediately before or immediately after the holding tank.

Alternatively, the carbohydrate sweetening agent(s) can be admixed with the cultured dairy base mix just prior to pumping the cultured dairy base mix through the cooling heat exchangers 31 to arrest the fermentation.

In certain embodiments, the methods comprise admixing about 0.2% to 1.2% stabilizer(s) into the cultured dairy product 30. Exemplary useful stabilizer(s) include, but are not limited to, gelatin, starch, pectin, carrageenan and mixtures thereof.

In certain embodiments, the preservative(s) can be admixed with the dairy base mix 11, and thereafter the carbohydrate sweetening agent(s) can be admixed with the cultured dairy base mix just prior to pumping the cultured dairy blend mix through the cooling heat exchangers 31. Alternatively, the preservative(s) can be admixed with the dairy base mix, and thereafter the carbohydrate sweetening agent(s) can be admixed with the cultured dairy base mix either immediately before or immediately after a holding tank 33.

In certain embodiments, the carbohydrate sweetening agents can be admixed with the dairy base mix 11, and thereafter the preservative(s) can be admixed with the cultured dairy base mix just prior to pumping the cultured dairy blend mix through the cooling heat exchangers 31. Alternatively, the carbohydrate sweetening agents can be admixed with the dairy base mix 11, and thereafter the preservative(s) can be admixed with the cultured dairy base mix either immediately before or immediately after a holding tank 33.

In an exemplary embodiment of the invention, the carbohydrate sweetening agent(s) provided can be pasteurized or sterilized prior to addition to the cultured dairy base mix thereby producing a heat treated carbohydrate sweetening agent(s). The pasteurization or sterilization method of the carbohydrate sweetening agent(s) can be identified by one skilled in the art, for example in the case of sterilization a light pulse, ultra high temperature, ultra high pressure, ultraviolet irradiation, ultra filtration, etc. can be used.

Alternatively, the carbohydrate sweetening agent(s) can be pasteurized either through batch pasteurization or high temperature, short time (HTST) pasteurization. Since it is intended that the carbohydrate sweetening agent(s) can be added directly to an already cultured dairy base mix, pasteurization or sterilization provides bacteriological stability for a cultured dairy base mix/carbohydrate sweetening agent(s) blend product that does not receive further bacteriological treatment, such as for example a heat treatment process.

Additionally, pasteurization or sterilization of the carbohydrate sweetening agent(s) can allow for production of the carbohydrate sweetening agent(s) at one production facility and thereafter transportation to a separate dairy product manufacturing facility, thereby reducing the spoilage potential of the carbohydrate sweetening agent(s) during transport and storage. The carbohydrate sweetening agent(s) can be pasteurized or sterilized, packaged and transported from a production facility to a separate dairy product manufacturing facility in about one metric ton quantities via appropriate aseptic stainless steel containers, commonly referred to as totes.

Alternatively, the carbohydrate sweetening agent(s) can be pasteurized or sterilized at the dairy product manufacturing facility in a continuous or batch system and immediately admixed with the cultured dairy base mix.

Thus, in an exemplary embodiment of the invention the carbohydrate sweetening agent(s) are pasteurized. In an embodiment, the carbohydrate sweetening agent(s) were treated with a heat treatment at a temperature of about 71° C. (160° F.) for 20 seconds. Also carbohydrate sweetening agent(s) that are sterile, i.e., characterized by an absence of any viable microorganisms and even viable bacteriological or mold spores, i.e., and even more bacteriologically stable than aseptic products can be used. Additionally, carbohydrate sweetening agent(s) that are aseptic, i.e., having a plate count of less than 10¹ and thus have a higher level of bacteriological stability than mere pasteurization can be used. The pasteurization and sterilization methods used to treat the carbohydrate sweetening agent(s) can also be used to heat treat the carbohydrate sweetening agent(s) blend producing a heat treated carbohydrate sweetening agent(s) blend.

The preservative(s) preparation can comprise admixing a concentration of preservative(s) to water in a ratio of about 1:4 to about 4:1 to form a clear preservative(s) blend. In certain embodiments, a preservative(s) to water in a ratio of about 2:3 to 3:2 to form the clear preservative(s) blend can be used. Exemplary useful preservative(s) include, but are not limited to, potassium sorbate, sodium benzoate or mixtures thereof. Useful herein is potassium sorbate.

In an exemplary embodiment of the invention, the preservative(s) provided can be pasteurized or sterilized prior to addition to the cultured dairy product, thereby producing a heat treated preservative(s). The pasteurization or sterilization method of the preservative(s) can be identified by one skilled in the art, for example in the case of sterilization a light pulse, ultra high temperature, ultra high pressure, ultraviolet irradiation, ultra filtration, etc. can be used.

Alternatively, the preservative(s) can be pasteurized either through batch pasteurization or high temperature, short time (HTST) pasteurization. Since it is intended that the preservative(s) can be added directly to an already cultured dairy product, pasteurization or sterilization provides bacteriological stability for a cultured dairy base mix/preservative(s) blend product that does not receive further bacteriological treatment, such as for example a heat treatment process.

Additionally, pasteurization or sterilization of the preservative(s) can be used to allow for production of the preservative(s) at one production facility and thereafter transportation to a separate dairy product manufacturing facility. The preservative(s) can be pasteurized or sterilized, packaged and transported from a production facility to a separate dairy product manufacturing facility.

Alternatively, the preservative(s) can be pasteurized or sterilized at the dairy product manufacturing facility in a continuous or batch system and immediately admixed with the cultured dairy base.

In an exemplary embodiment of the invention are preservative(s) that are pasteurized. In an embodiment, the preservative(s) is at least pasteurized and cooled to a temperature of about 4° C. to about 30° C. (39° F. to about 86° F.). In certain embodiments, the preservative(s) is at least pasteurized and cooled to a temperature of about 4° C. to about 15° C. (39° F. to about 59° F.). In certain embodiments, the preservative(s) is at least pasteurized and cooled to a temperature of about 4° C. to about 7° C. (39° F. to about 45° F.). Preservative(s) that are sterile, i.e., characterized by an absence of any viable microorganisms and even viable bacteriological or mold spores, i.e., and even more bacteriologically stable than aseptic products can be used. Additionally, preservative(s) that are aseptic, i.e., having a plate count of less than 10¹ and thus have a higher level of bacteriological stability than mere pasteurization can be used. The pasteurization and sterilization methods used to treat the preservative(s) can also be used to treat the preservative blend, thereby producing a heat treated preservative(s) blend.

In an exemplary embodiment of the invention, the stabilizer(s) provided can be pasteurized or sterilized prior to addition to the cultured dairy base mix, thereby producing a heat treated stabilizer(s). The pasteurization or sterilization method of the stabilizer(s) can be identified by one skilled in the art, for example in the case of sterilization a light pulse, ultra high temperature, ultra high pressure, ultraviolet irradiation, ultra filtration, etc. can be used.

Alternatively, the stabilizer(s) can be pasteurized either through batch pasteurization or high temperature, short time (HTST) pasteurization. Since it is intended that the stabilizer(s) can be added directly to an already cultured dairy base mix, pasteurization or sterilization provides bacteriological stability for a blended cultured dairy base mix/stabilizer(s) blend that does not receive further bacteriological treatment, such as for example a heat treatment process.

Additionally, pasteurization or sterilization of the stabilizer(s) can be used to allow for production of the stabilizer(s) at one production facility and thereafter transportation to a separate dairy product manufacturing facility. The stabilizer(s) can be pasteurized or sterilized, packaged and transported from a production facility to a separate dairy product manufacturing facility.

In an alternative embodiment, the carbohydrate sweetening agent(s) blend and preservative(s) blend can be admixed together to form a carbohydrate sweetening agent(s)/preservative(s) blend prior to injection into the cultured dairy base stream. The carbohydrate sweetening agent(s)/preservative(s) blend can be pasteurized or sterilized prior to injection into the yogurt base stream. In an alternative embodiment, the carbohydrate sweetening agent(s), preservative(s), and stabilizer(s) can be admixed together to form a carbohydrate sweetening agent(s)/preservative(s)/stabilizer(s) blend prior to injection into the cultured dairy base mix stream. The carbohydrate sweetening agents/preservative(s)/stabilizer(s) blend can be pasteurized or sterilized prior to injection into the cultured dairy base mix stream. The pasteurization or sterilization method can be identified by one skilled in the art, and the methods mentioned for the individual pasteurization or sterilization of the carbohydrate sweetening agent(s), preservative(s), carbohydrate sweetening agent(s) blend, preservative(s) blend, and stabilizer(s) preparations can be used to treat a blend combination that includes at least two of the following: carbohydrate sweetening agent(s), carbohydrate sweetening agent(s) blend, preservative(s), preservative(s) blend, and stabilizer(s). The blend combination can then be added to the cultured dairy base mix. Alternatively, the carbohydrate sweetening agent(s), preservative(s), carbohydrate sweetening agent(s) blend, preservative(s) blend, and stabilizer(s) can be pasteurized or sterilized individually and thereafter blended to form one of the blend combinations that include at least two of the following: carbohydrate sweetening agent(s), carbohydrate sweetening agent(s) blend, preservative(s), preservative(s) blend, and stabilizer(s). In another embodiment, the blend combinations that include at least two of the following: carbohydrate sweetening agent(s), carbohydrate sweetening agent(s) blend, preservative(s), preservative(s) blend, and stabilizer(s) can be produced at one production facility and thereafter transported to a separate dairy product manufacturing facility. The blend combinations that include at least two of the following: carbohydrate sweetening agent(s), carbohydrate sweetening agent(s) blend, preservative(s), preservative(s) blend, and stabilizer(s) can be pasteurized or sterilized, packaged and transported from a production facility to a separate dairy product manufacturing facility in about one metric ton quantities via appropriate aseptic stainless steel containers, commonly referred to as totes. Alternatively, the blend combinations that include at least two of the following: carbohydrate sweetening agent(s), carbohydrate sweetening agent(s) blend, preservative(s), preservative(s) blend, and stabilizer(s) can be packaged and transported in a variety of containers easily identified by one skilled in the art.

The cultured dairy base mix including at least one of carbohydrate sweetening agent(s), carbohydrate sweetening agent(s) blend, preservative(s), preservative(s) blend, and stabilizer(s) heat treated and added post fermentation or other cultured dairy products such as yogurt can be transported to a holding tank and then to a filler, and finally placed in a conventional container such as a coated paper or plastic cup or tube fabricated from a flexible film producing a finished cultured dairy product or finished yogurt product. In an exemplary embodiment the yogurt can be held in the holding tank for about 5 to about 15 minutes. After filling 50, the filled containers are applied with a lid or other closure or seal means, assembled into cases and entered into refrigerated storage for distribution and sale.

In certain embodiments, particularly low fat and/or low calorie variations, the dairy product can comprise a high potency non- carbohydrate sweetening agent. Exemplary high potency sweeteners include aspartame, sucralose, potassium acelsulfame, saccharin, cyclamates, thaumatin and mixtures thereof.

The dairy product can additionally include flavors. Illustrative flavors include vanilla, amaretto, cheesecake, white chocolate, Café Au Lait, caramel apple, banana cream, lemon, lime, various fruit and berry flavors, and mixtures thereof.

The dairy product can additionally include a conventional fruit sauce or puree. If present, the fruit constituent can comprise about 5% to about 15% of the cultured dairy base mix. The method can thus comprise the optional additional step of adding a fruit sauce or puree 40.

In the manufacture of Swiss-style yogurt, a fruit sauce or puree is blended substantially uniformly throughout the cultured dairy base mix after fermentation is complete but prior to packaging. A static mixer 41 can be used to blend the fruit sauce or puree into the cultured dairy base mix with minimal shear.

In the manufacture of “sundae” style yogurt, fruit sauce or puree is deposited at the bottom of the consumer container, and the container is then filled with the cultured dairy base mix. To prepare a sundae style yogurt product employing a stirred style yogurt, the cultured dairy base mix is prepared with added thickeners and/or stabilizer(s) to provide upon resting a yogurt texture that mimics a “set” style yogurt. In this variation, the fruit sauce or puree is added directly to the container, typically to the bottom, prior to filling with the cultured dairy base mix.

The fruit sauce or puree used in the invention may be any of a variety of conventional fruit flavorings commonly used in yogurt products. Typical flavorings include cherry, kiwi, key lime, strawberry, raspberry, blueberry, strawberry-banana, boysenberry, cherry-vanilla, peach, pineapple, lemon, orange and apple. Generally, fruit flavorings include fruit preserves and fruit or fruit puree, with any of a combination of sweeteners, starch, stabilizer(s), natural and/or artificial flavors, colorings, water and citric acid or other suitable acid to control the pH.

Other items can be added into fruit sauces or purees as well, such as flavored fat-based chips or particulates.

If a high potency sweetening agent is added to the cultured dairy product, all or a portion of the high potency sweetening agent can be pre-blended with the fruit flavoring sauce or puree.

The products can additionally include a variety of other ingredients to increase their nutritional, organoleptic or other consumer appeal, e.g., fruit pieces, nuts, partially puffed cereals, etc.

While the invention has been described in connection with what is presently considered to be the most practical and exemplary embodiments, it is to be understood that the invention is not to be limited to the disclosed embodiments, but on the contrary, is intended to cover various modifications and equivalent arrangements included within the spirit and scope of the appended claims.

Throughout the specification and claims, percentages are by weight and temperatures in degrees Celsius unless otherwise indicated.

1. A method of producing a cultured dairy product, comprising the steps of:
A. providing a heat treated dairy base mix;
B. inoculating the heat treated dairy base mix with a starter culture to form an inoculated dairy base mix;
C. fermenting the inoculated dairy base mix to provide a cultured dairy base mix;
D. cooling the cultured dairy base mix to a temperature of about 0° C. to about 5° C. (41° F.) to arrest fermentation;
E. adding about 0.005% to about 0.20% of a heat treated preservative(s) blend to the cultured dairy base mix:

2. The method of claim 1, additionally comprising adding about 0% to about 25% of a heat treated carbohydrate sweetening agent(s) after cooling the cultured dairy base mix to arrest fermentation.

3. The method of claim 2 wherein the heat treated carbohydrate sweetening agent(s) is treated via ultraviolet irradiation.

4. The method of claim 2 additionally comprising; co-blending the carbohydrate sweetening agent(s) with water in a ratio of carbohydrate sweetening agent(s) to water ranging from about 1:1 to about 4:1 to form a sweetening agent blend.

5. The method of claim 4 wherein the carbohydrate sweetening agent(s) blend is heat treated via ultraviolet irradiation.

6. The method of claim 1, additionally comprising adding about 0% to about 25% of a heat treated carbohydrate sweetening agent after fermenting the inoculated dairy base.

7. The method of claim 1, additionally comprising adding about 0.2% to about 1.2% heat treated stabilizer(s) after cooling the cultured dairy base to arrest fermentation.

8. The method of claim 1 wherein the preservative(s) is selected from the group consisting of potassium sorbate, sodium benzoate, and mixtures thereof.

9. The method of claim 1 wherein the heat treated dairy base mix comprises:
a. about 4% to about 12% milk solids;
b. about 0.1% to about 6% fat; and
c. about 0% to about 25% sweetening agents.

10. The method of claim 9 wherein the heat treated dairy base mix has a total solids of at least 15%.

11. The method of claim 9 wherein the heat treated dairy base mix has a total solids of at least 25%.

12. The method of claim 1 wherein the cultured dairy base mix is a yogurt product.

13. The method of claim 1 additionally comprising; co-blending the preservative(s) with water in a ratio of preservative(s) to water ranging from about 1:4 to about 4:1 to form a preservative(s) blend.

14. A method of producing a cultured dairy product, comprising the steps of:
a. providing a heat treated dairy base mix;
b. inoculating the heat treated dairy base mix with a starter culture to form an inoculated dairy base mix;
c. fermenting the inoculated dairy base to provide a cultured dairy base mix;
d. cooling the cultured dairy base mix to a temperature of about 0° C. to about 5° C. (32° F. to about 41° F.) to arrest fermentation;
e. adding about 0% to about 25% of a heat treated carbohydrate sweetening agent(s) to the cultured dairy base mix.

15. The method of claim 14, additionally comprising adding about 0.005% to about 0.20% of a heat treated preservative(s) blend after cooling the cultured dairy base mix to arrest fermentation.

16. The method of claim 15 wherein the heat treated preservative(s) blend is treated via ultraviolet irradiation.

17. The method of claim 14, additionally comprising adding about 0.005% to about 0.20% of a heat treated preservative(s) blend after fermenting the inoculated dairy base mix.

18. The method of claim 14, additionally comprising adding about 0.2% to about 1.2% heat treated stabilizer(s) after cooling the cultured dairy base to arrest fermentation.

19. The method of claim 14 wherein the heat treated dairy base mix comprises:
e. about 4% to about 12% milk solids;
f. about 0.1% to about 6% fat; and
g. about 0% to about 25% sweetening agents.

20. The method of claim 19 wherein the heat treated dairy base mix has a total solids of at least 15%.

21. The method of claim 19 wherein the heat treated dairy base mix has a total solids of at least 25%.

22. The method of claim 14 wherein the cultured dairy base is a yogurt product.
